(19) United States
(12) Patent Application Publication
(10) Pub. No.: US 2014/0177256 A1
(43) Pub. Date: Jun. 26, 2014

(54) HEADLIGHT APPARATUS

(71) Applicant: HELLA KGAA HUECK & CO., Lippstadt (DE)

(72) Inventor: Hans-Christian Schall, Bad Lippspringe (DE)

(73) Assignee: Hella KGaA Hueck & Co., Lippstadt (DE)

(21) Appl. No.: 13/722,268

(22) Filed: Dec. 20, 2012

(51) Int. Cl. B60Q 1/04

(52) U.S. Cl. CPC B60Q 1/0408
USPC 362/520

(57) ABSTRACT

A headlight for a vehicle has a housing and a headlight lens which together close off an interior space of the headlight. The headlight has at least one support rib which is positioned outside of the interior space and is connected to the headlight lens, wherein a support element is present on the support rib, and has at least one support segment, wherein a component of the vehicle chassis can be supported on said support segment, and wherein the support segment can slide relative to the support rib along a buffer path on the support rib.

The invention relates to a headlight for a vehicle, a support element, particularly for use in a headlight, and to a vehicle having at least one headlight.

Headlights for vehicles are known, and are used to illuminate the road in front of vehicles. For this purpose, known headlights are configured with a housing and a headlight lens which enclose an interior space in which individual headlight components, such as light-generating modules, optical elements, or electrical inserts, are arranged. This interior space is preferably sealed to prevent water from penetrating from the outside. Moreover, it is known that headlight lenses of known headlights have support ribs on which components of the vehicle chassis are supported. Such chassis components are, by way of example, bumper claddings which clad the bumper on the front of a vehicle. These bumper claddings are supports on the support ribs of the headlight lens, and are mechanically fixed to the headlight in this manner.

In the known headlights, it is disadvantageous that smaller deformations of the chassis component can leads to deformations, cracks, and even breaks in the support rib, and therefore in the headlight lens. This is particularly the case because the headlight lens of the headlight is frequently exposed to aggressive media. In particular, the cleaning agents of a headlight cleaning system constitute such an aggressive medium, which produces micro-fissures in the support rib as well as the headlight lens over the long-term use of a headlight. At this point, if a vehicle with such a headlight is driven into a stationary object during the process of parking, the chassis component shifts relative to the headlight, and exerts a force on the support rib. This exertion of force can lead to the support rib tearing or breaking off; and moreover, a break in the seal of the headlight can be produced via the support rib or other segments of the headlight lens. This can lead to a defect in the headlight, such that even small collisions which are themselves not problematic would lead to high repair costs.

The problem addressed by the present invention is that of providing a headlight which addresses the problems named above. In particular, the problem addressed by the invention is that of providing a headlight which can prevent, in a cost-effective manner, the headlight lens of the headlight from losing its seal as the result of cracks generated in small collisions, for example parking accidents. In addition, a particular problem addressed by the present invention is that of providing a corresponding vehicle, and a support element for use in a headlight.

The problems listed above are addressed by a headlight having the features of independent claim 1, a support element having the features of independent claim 8, and a vehicle having the features of independent claim 9. Further features and details of the invention are found in the dependent claims, the description, and the drawings. Here, features and details which are described in the context of the headlight according to the invention also apply equally in the context of the support element according to the invention and to the vehicle according to the invention, and vice-versa, such that disclosures of individual aspects of the invention always apply equally and/or can also apply equally in the other contexts.

A headlight according to the invention for a vehicle has a housing and a headlight lens which together enclose an interior space of the headlight. Further components of the headlight are accommodated in this interior space, particularly illuminating means, optical devices, and electronics. In addition, according to the invention, at least one support rib is arranged outside of the interior space and is connected to the headlight lens. The connection between the support rib and the headlight lens in this case is preferably realized in a force-fitting manner, such that it is possible for force to be transmitted from the support rib to the headlight lens. A headlight according to the invention is characterized in that a support element is present on the support rib. This support element has at least one support segment, and a chassis component of the vehicle can be supported on said support segment. The ability of the chassis component, and particularly a cladding component of the vehicle, to be supported is realized substantially in a unidimensional direction of force. This means that a simple supporting is sufficient, and a further fastening of the chassis component with respect to other directions in which movement can occur is not strictly necessary. According to the invention, the support segment of the support element is able to slide relative to the support rib, on the support rib, along a buffer path. The ability of the support segment to slide can be based on the support segment of the support element partially, or also completely, surrounding the support rib. The buffer path in this case can be realized along a straight track or also along a track which is at least partially curved.

According to the invention, a relative movement between the support segment and the support rib can occur because the buffer path allows such a relative movement. As a result, a chassis component which is supported on the support segment of the support element can likewise execute a relative movement with respect to the support rib along the buffer path. This relative movement is possible without the need for the chassis component to detach from the support segment—that is, particularly with a friction-fit connection between the chassis component and the support segment. As such, the support segment and therefore also the chassis component can move relative to the support rib along the buffer path if a force is exerted on the chassis component externally. By way of example, if the chassis component is displaced as the result of the force of wind or a parking accident of the vehicle, this displacement can occur together with the support segment of the support element relative to the support rib, without the need for a corresponding force to be immediately transmitted to the support rib. Rather, it is sufficient for the relative movement to take place along the buffer path, wherein the support rib is protected in this way.

Only when the buffer path is exhausted, meaning that the chassis component, and with it the support segment, have traveled the complete buffer path, is there a limiting stop between the support segment of the support element and the support rib. At this point in time, the complete force is transmitted because no more relative movement is possible, such that at this point the danger exists that the support rib will break and the headlight will lose its seal. Because, however, the buffer path is preferably designed in such a manner that it compensates smaller parking collisions and/or smaller displacements of the chassis component, it is possible in this way to prevent such small mechanical loads of the chassis component from leading to damage of the headlight. This increases the useful life of a headlight according to the invention. Even a failure of the support element during the movement along the buffer path can be acceptable in this case, because such a mechanically failed support element is more cost-effective and significantly simpler to exchange than a defective headlight. The buffer path in this case can also be called a “free travel” path.

It can be advantageous if the support element in a headlight according to the invention has at least one mounting segment. This mounting segment is at least partially connected to the support segment in a removable manner. In addition, the mounting segment mounts the support element on the support rib and/or the headlight lens. The mounting in this case is the mechanical fastening of the support element in its resting position. In other words, in this configuration, a relative movement can still take place between the support segment and the mounting segment. One possibility for a removable connection is a zipper-like connection which is broken at a certain separation force, such that the desired relative movement according to the invention can take place. Of course, other alternative embodiments of a removable connection can be contemplated as well, however. As such, it is possible that the hook-and-loop principle is selected in order to achieve a defined and increased friction fit between the mounting segment and the support segment, wherein said fit is broken at a predefined force. Here as well, in the context of the present invention, the connection is at least partially detachable. However, a pure friction connection with no hook-and-loop components can be used in the context of the present invention. A sawtooth profile with at least some degree of friction fit can also be contemplated, such that a locking of the individual sawtooth profile teeth can occur upon the movement of the support segment relative to the mounting segment. Both the mounting segment and the support segment are preferably made of a hard material, particularly a hard plastic. By way of example, this can be a thermoplastic material which is manufactured by means of an injection molding process.

It is also advantageous if the detachable connection in a headlight according to the invention, between the mounting segment and the support segment, is realized via at least one predetermined breaking point. This predetermined breaking point can be a geometric predetermined breaking point, for example—particularly a score line. In addition, complete weakenings of the material, such as holes or longitudinal slots along a predetermined breaking line, can be contemplated in the context of the present invention for the purpose of designing the at least one predetermined breaking point. This means that, in normal use, meaning particularly directly after the installation of the chassis component on the headlight according to the invention, the support segment is geometrically fastened to the mounting segment by the detachable connection. At this point, if a force which is applied to the support element via the chassis component reaches a predefined maximum value, then the predetermined breaking point separates, and/or the detachable connection breaks between the mounting segment and the support segment. The relative movement between the support segment and the support rib follows in a manner according to the invention, wherein the mounting segment remains fastened on the support rib or the headlight lens. In this manner, it is possible to preserve the required stability in normal use situations of the headlight, because enough force can be transmitted via the predetermined breaking point for the normal use situation. An undesired relative movement in normal operation, along the buffer path, is avoided in this manner. At the same time, it is possible to set the desired separation force by means of the design of the predetermined breaking point, such that the threshold minimum for the parking collision preferably is lower than the mechanical load threshold of the support rib. As such, it is possible for the protective mechanism of the relative movement along the buffer path to be initiated, so to speak, via the predetermined breaking point or via the detachable connection before the support rib or the headlight lens can be given an excessive mechanical load.

It is a further advantage here if the support element of a headlight according to the invention has at least one seal segment, by means of which the joint between the chassis component and the headlight lens can be sealed. This seal segment can be termed a so-called cw-seal, and serves to improve the cw value of the vehicle. As such, the configuration prevents an undesired flow of air through the interior space of the chassis of the vehicle. The seal segment in this case is preferably manufactured from a soft material, particularly from a soft plastic. By way of example, the seal segment can be manufactured from EPRD—that is, an elastomer. The seal segment in this case serves to create a seal for the predefined joint between the support element in its geometric design and the chassis component.

It can likewise be advantageous if the support element, and particularly all the segments of the support element, in a headlight according to the invention, are designed as a single, particularly integral, piece. In particular, the support segment, the mounting segment, and/or the seal segment in this case are designed as a single and/or integral piece together. A design using plastic is preferred in this case for all segments, wherein different plastic components can be used for the integral design. Such a support element is preferably manufactured in a two-component injection molding process, such that it is possible to use, by way of example, a hard material for individual segments such as the support segment and the mounting segment, and a soft material for the seal segment, despite the integrated injection molded design. Such an embodiment using a single-piece, particularly integral, construction carries a cost advantage in the manufacture of the headlight.

It is likewise advantageous if the support element in a headlight according to the invention, and particularly the support segment, at least partially surrounds the support rib. In this case, the support element can be designed at least partially as a u-beam or as a c-beam, such that it is possible to realize an improved support on the support rib. In other words, the support element is a type of adapter between the chassis component and the support rib which can provide the desired buffer path. The enclosure or partial enclosure by the support element, and therefore the at least partial surrounding of the support rib, leads to a configuration wherein the support element is even more fixed in its position on the support rib, and particularly guided laterally. In particular, the configuration avoids an undesired removal, pulling, or sliding of the support element off of the support rib in this manner.

In the context of the present invention, it can likewise be advantageous if the support element of a headlight according to the invention has a support surface on which the chassis component can be supported, and on which the chassis component can move relative to the support element along a chassis buffer path. In other words, this is a second buffer path which can be included additionally to the buffer path of the support element. This function can also be termed a “telescope principle,” such that the two buffer paths—namely the buffer path of the support element and the chassis buffer path, complement each other, and can execute their relative movements separately or at the same time. As such, it is possible to provide a complete buffer path without affecting the construction of the support element, wherein said complete buffer path is larger than the simple buffer path of the support element, and thereby protection can be realized even from larger deformations of the chassis component and therefore larger applications of force onto the chassis component, according to the invention.

A further subject of the present invention is a support element, particularly for use in a headlight according to the invention. A support element according to the invention has at least one support segment, and a chassis component of the vehicle can be supported on said support segment. In addition, this support segment of a support element according to the invention can slide along a buffer path on the support rib relative to the support rib of a headlight. This support element can also be understood as a replacement path for a headlight according to the invention. Moreover, a support element according to the invention can also be used in already extant headlights produced according to the prior art, equipping the same with the quality according to the invention. Accordingly, a support element according to the invention has the same advantages as those which have already been thoroughly explained with respect to the headlight according to the invention.

A further subject of the present invention is also a vehicle which has at least one headlight according to the invention. Accordingly, a vehicle according to the invention has the same advantages as those which have already been thoroughly explained with respect to the headlight according to the invention.

In the following, the invention is explained in greater detail using the attached drawings. The terms “left,” “right,” “above” and “below” used below refer to an orientation of the drawn figures when the reference numbers are read normally. In the figures,

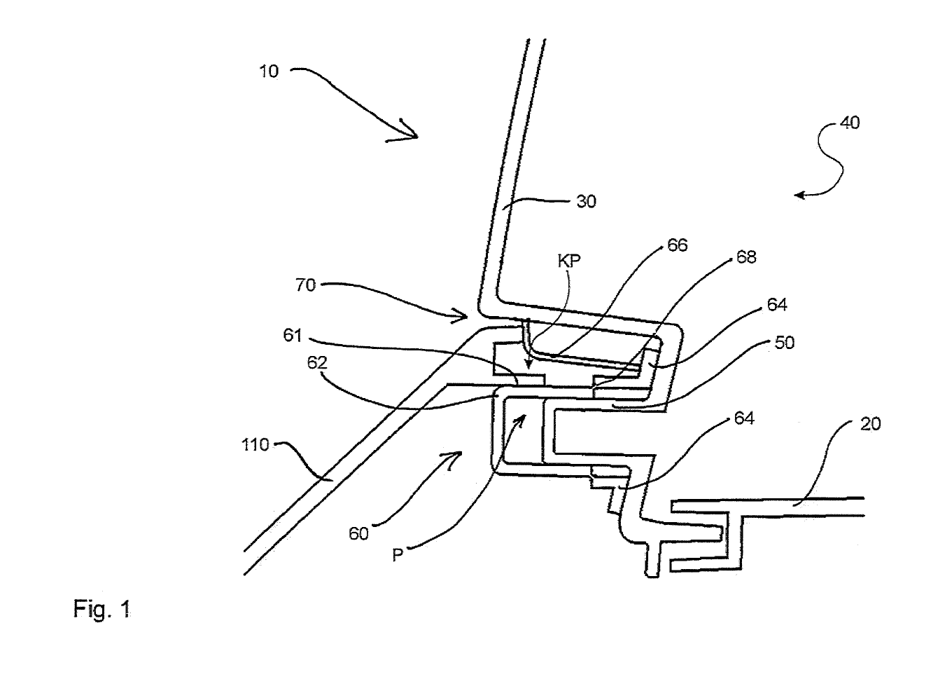

FIG. 1 shows a schematic cross-section of a first embodiment of a headlight according to the invention,

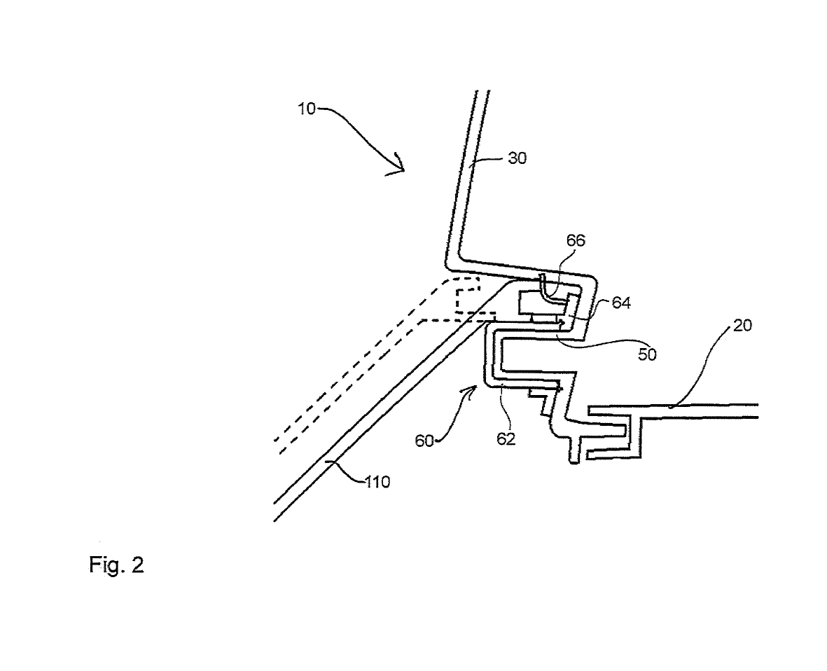

FIG. 2 shows the embodiment in FIG. 1 following a parking collision,

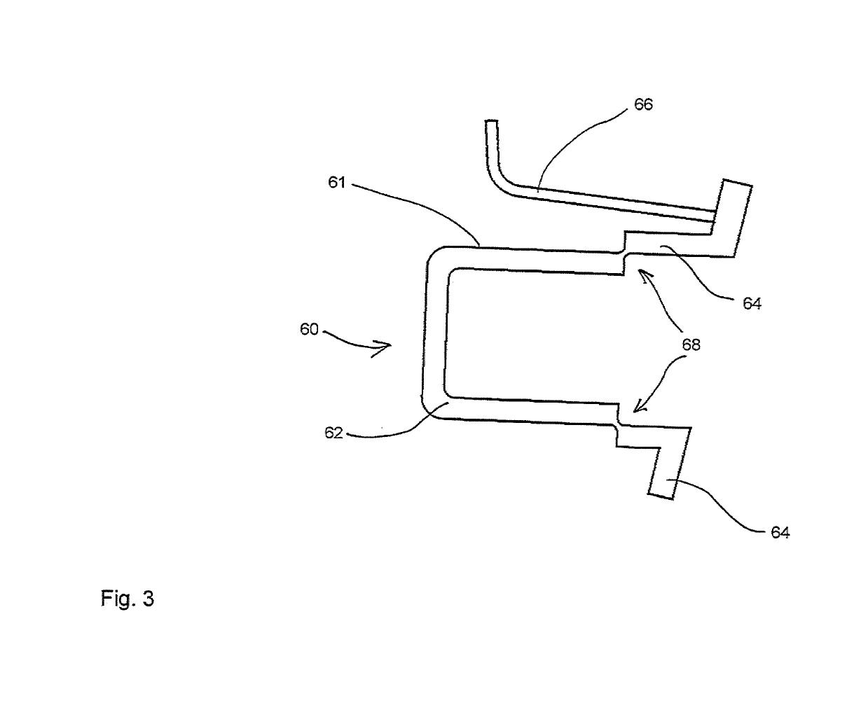

FIG. 3 shows an embodiment of a support element according to the invention, and

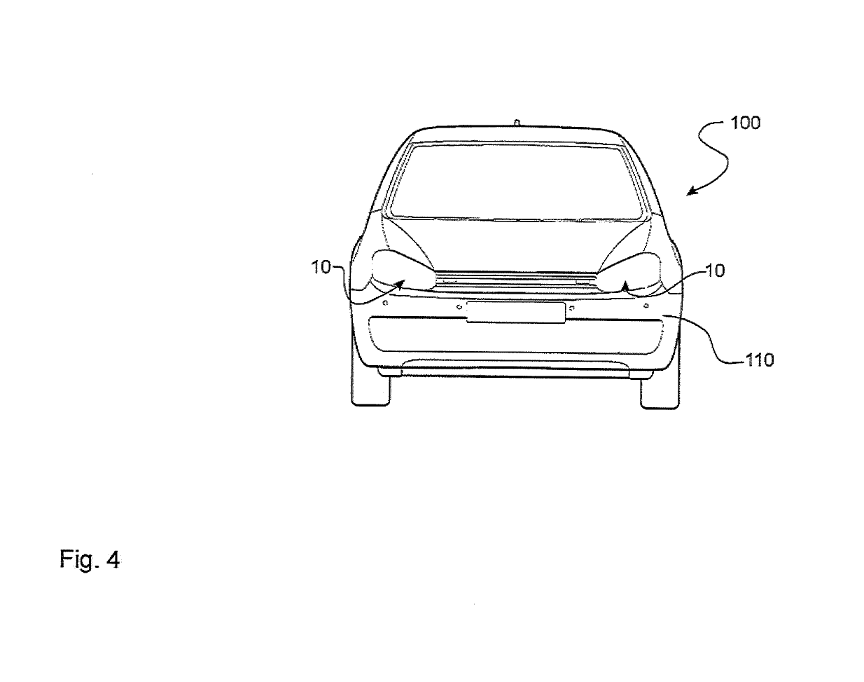

FIG. 4 shows an embodiment of a vehicle according to the invention.

FIG. 1 shows a schematic cross-section of a first embodiment of a headlight 10 according to the invention. The headlight 10 has a housing 20 and a headlight lens 30 which together enclose an interior space 40 of the headlight 10. For reasons of visual clarity, the electrical and light-emitting installations in the interior space 40 of the headlight 10 are not illustrated in FIG. 1. Moreover, a seal—which is likewise not illustrated—can be included between the headlight lens 30 and the housing 20 in order to substantially protect the interior space 20 from the penetration of fluids.

The headlight lens 30 of a headlight 10 according to the invention is equipped with a support rib 50, on which a support element 60 is arranged. The support element 60 in this embodiment is substantially pressed over the support rib 50 with a c-beam shape, and is mounted on the support rib 50 and/or on the headlight lens 30 via the mounting segment 64.

In addition to the mounting segment 64, the support element 60 also has a support segment 62. This support segment 62 has a support surface 61 on which a chassis component 110 is supported. The chassis component 110 in this case is preferably a cladding, particularly a chassis cladding, of a vehicle 100. In particular, the chassis component 110 is the bumper cladding of the vehicle 100.

A detachable connection in the form of a predetermined breaking point 68 is included in the support element 60 in this embodiment, between the support segment 62 and the mounting segment 64. At this point, if a movement of the chassis component 110 is generated by a parking collision of the vehicle 100, the chassis component 110 moves toward the headlight 10. In this embodiment, there is a doubled complete buffer path, because in addition to the buffer path P of the support element 60, a chassis component buffer path KP is also included. As a result, a relative movement occurs between the chassis component 110 and the support element 60, as well as a relative movement between the support segment 62 and the support rib 50. So that it is possible for the latter relative movement to be carried out, the predetermined breaking point 68 breaks, and releases the detachable connection, such that the support segment 62 can move not only relative to the support rib 50, but rather also relative to the mounting segment 64.

The end of such a movement is shown in FIG. 2. In this case, the chassis component 110 is displaced to the maximum extent relative to the support element 60, and the support segment 62 is also displaced to the maximum extent relative to the support rib 50. This position can also be characterized as the completely retracted or completely buffered position. Once the chassis component 110 has arrived in this position, a further application of force would potentially lead to the support rib 50 being torn off, and therefore to a break in the seal of the headlight 10. However, as long as the buffer path P is available, such an application of force is prevented via this buffer path and the corresponding relative movement, such that it is possible to prevent the support rib 50 from tearing off, and therefore to prevent the headlight 10 from losing its seal.

It can be further seen in FIGS. 1 and 2 that the support element 60 has a seal segment 66. In contrast to the support segment 62 and the mounting segment 64, made of a hard material, the seal segment 66 is made of a soft material. An elastomer plastic is preferably used in this case which seals the joint 70 in the desired manner against the penetration of air, particularly wind. Because the seal segment 66 can be a soft component, the same can also compensate the relative movement of the chassis component 110 relative to the support rib 50 in a spring-like manner, and particularly is compressed, as can be seen in the result shown in FIG. 2.

FIG. 3 shows one embodiment of a support element 60 according to the invention, as used, by way of example, in the headlight illustrated in FIGS. 1 and 2. This support element 60 has a support surface 61 on which the chassis component 110 can be supported—as illustrated in FIGS. 1 and 2. In addition, a support segment 62 is included which is detachably connected to the mounting segment 64 via predetermined breaking points 68. The design of these predetermined breaking points is realized in such a defined manner that they tear upon the application of a force which is less than the mechanical load threshold of the support rib 50 and/or the headlight lens 30. In this embodiment of the support element 60 as well, the same has a seal segment 66 made of a soft material, as has already been explained above.

FIG. 4 shows an embodiment of a vehicle 100 according to the invention, wherein this vehicle 100 is equipped with two front headlights 10 which can buffer a parking collision on the front of the vehicle 100 with the quality according to the invention, and can prevent a loss of the seal of each headlight 100. It can be clearly seen here that the chassis component 110 is the bumper cladding of the vehicle 100. Of course, it is also possible that the rear hatch lights of the vehicle 100 can be additionally or alternatively designed as headlights 10 in a manner according to the invention.

The above embodiments only describe the present invention as examples thereof. Of course, the features of the individual embodiments can be freely combined with each other, to the extent this is technically reasonable, without leaving the boundaries of the present invention.

### LIST OF REFERENCES

10 headlight

20 housing

30 headlight lens

40 interior space

50 support rib

60 support element

61 support surface

62 support segment

64 mounting segment

66 seal segment

68 predetermined breaking point

70 joint

100 vehicle

110 chassis component

P buffer path

KP chassis buffer path

1. A headlight for a vehicle, comprising:
a housing and a headlight lens, said housing and headlight lens together defining an interior space of said headlight, and
at least one support rib positioned outside of said interior space and connected with said headlight lens,
a support element on said support rib having at least one support segment, said support segment being operable for supporting at least one component of a vehicle chassis and said support segment being slidable relative to said support rib along a buffer path on said support rib.

2. The headlight according to claim 1, wherein said support element has at least one mounting segment which is connected in a removable manner to said support segment, at least sectionally, and said support element is mounted on at least one of said support rib and said headlight lens.

3. The headlight according to claim 2, wherein said mounting segment is connected with said support segment via at least one predetermined breaking point.

4. The headlight according to claim 1, wherein said support element has at least one seal segment operable for sealing a joint between said chassis component and said headlight lens.

5. The headlight according to claim 1, wherein said support element and said support segment are a single integral piece.

6. The headlight according to claim 1, wherein said support segment at least partially surrounds said support rib.

7. The headlight according to claim 1, wherein said support element further comprises a support surface operable for supporting said chassis component, and wherein said vehicle component is movable on said support surface relative to said support element along a chassis component buffer path.

8. A support element particularly for use in a headlight a vehicle having a housing and a headlight lens, said housing and headlight lens together defining an interior space of said headlight, and at least one support rib positioned outside of said interior space and connected with said headlight lens, said support element being on said support rib, said support element further comprising:
at least one support segment operable for supporting a chassis component of said vehicle and slidable relative to said support rib along a buffer path on said support rib.

9. A vehicle, comprising:
at least one headlight (10) having:
a housing and a headlight lens, said housing and headlight lens together defining an interior space of said headlight, and
at least one support rib positioned outside of said interior space and connected with said headlight lens,
a support element on said support rib having at least one support segment, said support segment being operable for supporting at least one component of a vehicle chassis and said support segment being slidable relative to said support rib along a buffer path on said support rib.

10. The vehicle according to claim 9, wherein said support element has at least one mounting segment which is connected in a removable manner to said support segment, at least sectionally, and said support element is mounted on at least one of said support rib and said headlight lens.

11. The vehicle according to claim 10, wherein said mounting segment is connected with said support segment via at least one predetermined breaking point.

12. The vehicle according to claim 9, wherein said support element has at least one seal segment operable for sealing a joint between said chassis component and said headlight lens.

13. The vehicle according to claim 9, wherein said support segment at least partially surrounds said support rib.

14. The vehicle according to claim 9, wherein said support element further comprises a support surface operable for supporting said chassis component, and wherein said vehicle component is movable on said support surface relative to said support element along a chassis component buffer path.

15. The headlight according to claim 1, wherein said support element at least partially surrounds said support rib.

16. The headlight according to claim 2, wherein said support element, said support segment, and said mounting segment are a single integral piece.

17. The headlight according to claim 4, wherein said support element, said support segment, and said seal segment are a single integral piece.

18. The headlight according to claim 2, wherein said support element has at least one seal segment operable for sealing a joint between said chassis component and said headlight lens and wherein said support element, said support segment, said mounting segment, and said seal segment are a single integral piece.
